(19) United States
(12) Patent Application Publication
(10) Pub. No.: US 2009/0290262 A1
(43) Pub. Date: Nov. 26, 2009

(54) CARRIAGE ARM ASSEMBLY, DISK DRIVE AND PRESSER MEMBER

(75) Inventor: Yasuo Suzuki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/358,818

(22) Filed: Jan. 23, 2009

(30) Foreign Application Priority Data
May 26, 2008 (JP) 2008-137323

(51) Int. Cl. G11B 5/55

(52) U.S. Cl. 360/264.2; G9B/5.182

(57) ABSTRACT

A carriage arm assembly includes: a carriage arm that holds a head slider and a head IC communicating with the head slider and has a first engagement part between the head slider and the head IC; a signal relay member that are provided on the carriage arm and relays signals between the head slider and the head IC; and a presser member that has a second engagement part engaged with the first engagement part and is attached to the carriage arm by engaging the first and second engagement parts with each other, the signal relay member being held by a projection provided in one of the carriage arm and the presser member and a recess that is provided in the other and is engaged with the projection.

### CROSS-REFERENCE TO RELATED APPLICATION

This application is based upon and claims the benefit of priority of the prior Japanese Patent Application No. 2008-137323, filed on May 26, 2008, the entire contents of which are incorporated herein by reference.

### FIELD

The present invention generally relates to a carriage arm assembly, a disk drive and a presser member, and more particularly, to a carriage arm assembly having a signal relay member, a disk drive equipped with the above carriage arm assembly, and a presser member that presses the signal relay member against a carriage arm.

### BACKGROUND

Recently, there has been considerable activity in the research and development of speeding up data transfers due to increase in the recording density in disk drives for data recording and reproduction. The speedup of data transfer requires improvements in a carriage arm assembly (which may be called head stack assembly) composed of a suspension and a carriage arm both having wiring lines for carrying signals. For example, the type of the carriage arm assembly is being changed to a short tail type from a long tail type. The short tail type has a shortened signal relay member integrally formed with a suspension, and the long tail type has a relatively long signal relay member.

In the long tail type, high-speed airflow in the vicinity of the signal relay member caused by rapid rotation of the disk may vibrate the signal relay member. Thus, vibration of the signal relay member vibrates the magnetic head. This degrades positioning accuracy necessary for high-density recording. It is thus required to restrain vibration of the signal relay member in order to realize high-density recording.

Recently, the long tail tape of signal relay member has been improved to reduce vibration. In this improvement, the signal relay member is in tight contact with the carriage arm, and an adhesive is dropped to the contact area. Thus, the signal relay member is bonded to the carriage arm.

The signal relay member must be detached from the carriage arm if the carriage arm assembly is determined as being faulty in the performance test of the head that is carried out after the carriage arm assembly is assembled. The bonding using adhesive causes the signal relay member to be peeled from the carriage arm. Adhesive remains on the signal relay member, and it is troublesome to remove the remaining adhesive.

In order to overcome the above drawback, there has been a proposal to hold an extended wiring part in the center of a groove in an extended wiring part holding part by utilizing repulsive force of a spring member (see Japanese Patent Application Publication No. 2005-243171). There is another proposal to form a slit for holding the signal relay line of long tail type in the actuator arm and hold both the parts due to the friction between the signal relay line and the actuator arm in the slit (see Japanese Patent Application Publication No. 2007-179683).

However, the first proposal may not provide satisfactory effects of restraining vibration because this proposal uses only the elastic force of the spring member that is as thin as, for example tens of μm, and has difficulty in securely attaching the extended wiring part to the extended wiring part holding part.

The second proposal does not fixedly attach the actuator arm and the long tail to each other and does not have sufficient restrain of vibration in certain revolutions of the disk.

### SUMMARY

According to an aspect of the present invention, there is provided a carriage arm assembly including: a carriage arm that holds a head slider and a head IC communicating with the head slider and has a first engagement part between the head slider and the head IC; a signal relay member that are provided on the carriage arm and relays signals between the head slider and the head IC; and a presser member that has a second engagement part engaged with the first engagement part and is attached to the carriage arm by engaging the first and second engagement parts with each other, the signal relay member being held by a projection provided in one of the carriage arm and the presser member and a recess that is provided in the other and is engaged with the projection.

According to another aspect of the present invention, there is provided a disk drive including: a disk medium; and a carriage arm assembly used to write and read data into and from the disk medium and configured as described above.

According to yet another aspect of the present invention, there is provided a presser member including: an engagement part engaged with an engagement part of a carriage arm having a head slider and a head IC; and a fitting portion engageable with one of a projection and a recess provided in the carriage arm in a state in which the presser member is engaged with the carriage arm, the fitting portion holding a signal relay member together with said one of the projection and the recess.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a plan view of a head disk drive according to an embodiment of the present invention;

FIG. 2A is a plan view of a head stack assembly, and FIG. 2B is a side view of the head stack assembly;

FIG. 3A through 3C are exploded perspective views of an end portion of the head stack assembly;

FIG. 4 is a perspective view of a presser member;

FIGS. 5A through 5F are respectively cross-sectional views that illustrate the presser member and signal relay members of long tail type;

FIG. 6 is a cross-sectional view illustrating effects brought about by holding signal relay members by the presser member and a carriage arm;

FIGS. 7A and 7B are cross-sectional views of tab portions of the presser member;

FIGS. 8A and 8B are cross-sectional views of a first variation of the combination of a projection and a recess;

FIGS. 9A and 9B are cross-sectional views of a second variation of the combination of the projection and the recess;

FIGS. 10A through 10C are cross-sectional views of a variation of a structure that realizes the engagement of the presser member and the carriage arm; and

FIGS. 11A and 11B are cross-sectional views of a variation in which slits are formed in the carriage arm.

### DESCRIPTION OF EMBODIMENTS

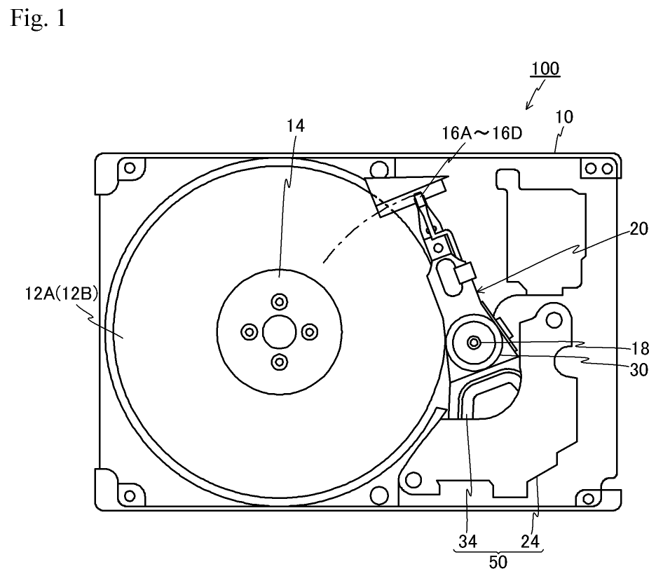

A description will now be given, with reference to FIGS. 1 through 7B, of embodiments of the present invention.

FIG. 1 depicts an internal structure of a hard disk drive (HDD) 100, which is an example of the disk drive in accordance with an embodiment of the present invention. As illustrated in FIG. 1, the HDD 100 has an enclosure 10 of a box type having an inner space (housing space) in which there are provided two magnetic disks 12A and 12B, a spindle motor 14, and ahead stack assembly (HSA) 20, which is an exemplary structure of a carriage arm assembly. The magnetic disk 12B is hidden behind the magnetic disk 12A. The enclosure 10 is composed of a base and an upper lid (top cover). In FIG. 1, only the base is illustrated for the sake of simplicity. The HDD is not limited to two disks and may have a single disk or three or more disks. The following description is directed to the HDD with the two disks.

Each of the disks 12A and 12B has front and back recording surfaces. The disks 12A and 12B are integrally rotated by the spindle motor 14 about a rotating shaft at a speed as high as 4200 rpm to 15000 rmp. Each of the magnetic disks 12A and 12B may a base plate on which an underlying layer, a magnetic layer, a protection film and a lubrication layer are laminated in this order. The base plate may be made of aluminum or glass. The underlying layer may be made of a Co—Cr alloy. The protection film may be a diamond like carbon (DLC) layer. The lubrication layer may be formed by organic liquid lubricant having a main chain of perfluoropropylene and an end group of hydroxyl group (—OH) or benzene ring.

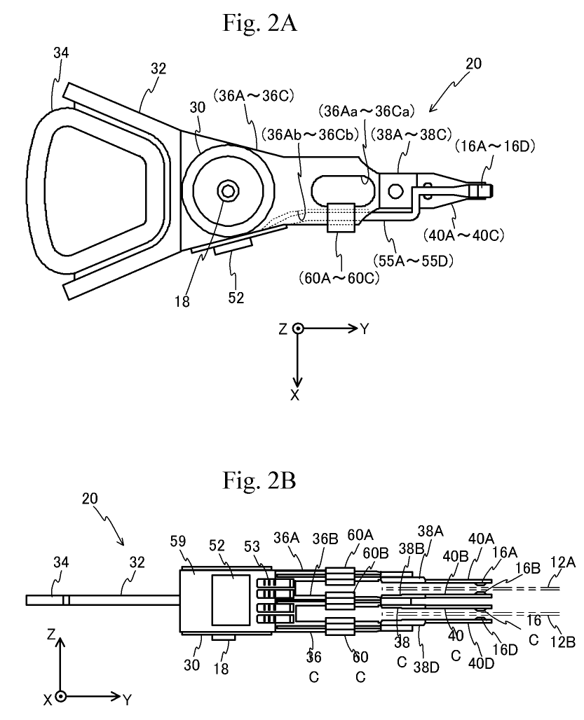

FIG. 2A is a plan view of the head stack assembly 20. In the following description, the short-side direction of the head stack assembly 20 is defined as an X-axis direction, and the long-side direction thereof is defined as a Y-axis direction. FIG. 2B is the head stack assembly 20 viewed from the +X direction to the −X direction.

As illustrated in FIGS. 2A and 2B, the head stack assembly 20 has a housing part 30, a fork part 32, a coil 34, three carriage arms 36A, 36B and 36C, four head sliders 16A, 16B, 16C and 16D, and ahead IC 52. The housing part 30 has a cylindrical shape. The fork part 32 is fixed to an end of the housing part 30 on the −Y side. The coil 34 is held by the fork part 32. The three carriage arms 36A, 36B and 36C are fixed to the housing part 30 at given intervals in the height direction (Z-axis direction). The four head sliders 16A, 16B, 16C and 16D are held by the three carriage arms 36A, 36B and 36C. The head IC 52 is attached to a sidewall of the housing part 30. The head stack assembly 20 is joined to the enclosure 10 via a bearing member 18 provided in the center of the housing part 30 so as to be free to rotate about the Z axis. A voice coil motor 50 is composed of the coil 34 of the head stack assembly 20 and a magnetic unit 24 (fixed to the enclosure 10) including a permanent magnet depicted in FIG. 1. The voice coil motor 50 drives the head stack assembly 20 to swing about the bearing shaft 18, as indicated by a one-dotted chain line in FIG. 1.

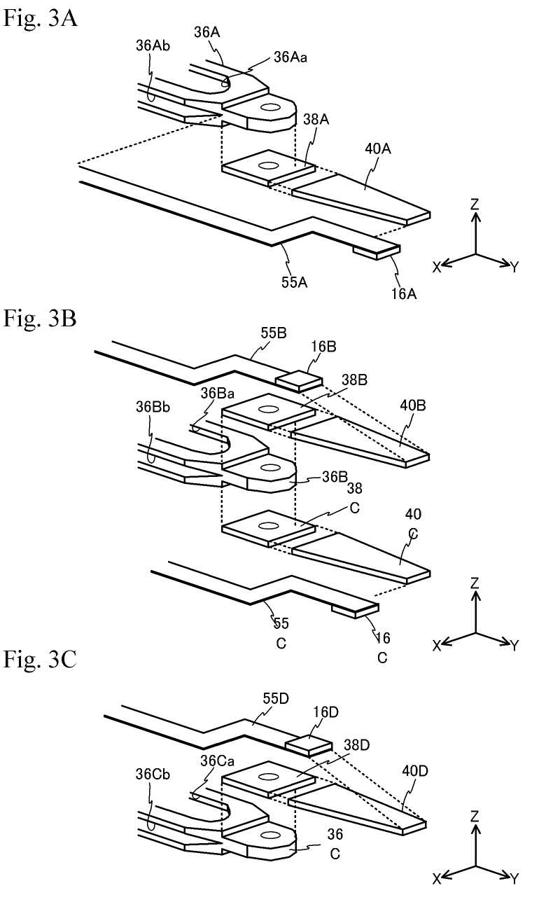

The carriage arms 36A-36C may be shaped by punching a stainless plate or extruding an aluminum member. As depicted in FIG. 2A, elliptic holes 36Aa-36Ca, which function as first engagement parts or arm-side engagement parts, are respectively formed in the carriage arms 36A-36C. It can be seen from FIG. 2A and FIGS. 3A through 3C that V-shaped grooves or slits 36Ab-36Cb are formed on sidewalls of the carriage arms 36A through 36C on the +X side.

As depicted in an exploded perspective view of FIG. 3A, the head slider 16A is provided on a lower surface side of an end portion of a head suspension 40A on the +Y side. The head suspension 40A is attached to the carriage arm 36A through a base plate 38A. As depicted in an exploded perspective view of FIG. 3B, the head slider 16B is provided on an upper surface side of an end portion of a head suspension 40B on the +Y side, which is attached to the carriage arm 36B through a base plate 38B. Similarly, the head slider 16C is provided on a lower surface side of an end portion of a head suspension 40C on the +Y side, which is attached to the carriage arm 36C through a base plate 38C. As depicted in an exploded perspective view of FIG. 3C, the head slider 16D is provided on an upper surface side of an end portion of a head suspension 40D on the +Y side, which is attached to the carriage arm 36D through a base plate 38D. The head sliders 16A and 16B face each other in the vertical (Z-axis) direction across the magnetic disk 12A, and the head sliders 16C and 16D face each other in the vertical (Z-axis) direction across the magnetic head 12B.

The head sliders 16A through 16D have respective recording/reproduction heads including recording elements and reproduction elements. Each recording element utilizes the magnetic field generated by a thin-film coil pattern to write data on the magnetic disk 12A (or 12B). Each reproduction element reads data from the magnetic disk 12A (or 12B) and may be a giant magneto-resistive (GMR) element utilizing resistance change of a spin-valve film or may be a tunnel junction magneto-resistive (TMR) element utilizing resistance change of a tunnel junction film.

The head suspensions 40A through 40D respectively support the head sliders 16A through 16D in a cantilever fashion due to gimbal springs (not depicted) at ends of the head suspensions 40A through 40D on the +Y sides. Pressing force from the head suspension 40A is exerted on the head slider 16A towards the front or back surface of the magnetic disk 12A. When the magnetic disk 12A rotates, ascending force is exerted on the head slider 16A due to the function of airflow that is generated on the surface of the magnetic disk 12A and is dependent on the rotation. The head slider 16A continues to fly with a relatively high rigidity during rotation of the magnetic disk 12A while the ascending force is balanced with the pressing force described above. Each of the other head suspensions 40B, 40C and 40D has the same function as that of the head suspension 40A. The head stack assembly 20 swings about the bearing member 18 when the head sliders 16A through 16D are flying, so that the recording/reproduction heads can be positioned on desired recording tracks on the magnetic disks 12A and 12.

As illustrated in FIGS. 2A and 2B, the head IC 52 is mounted on a flexible board 59 to which wiring patterns and terminals 53 are fixed on the +X side of the housing part 30. A flexible connector (not illustrated) connected to a printed circuit board of the HDD 100 is connected to the flexible board 59. The head IC 52 is electrically connected to a hard disk controller on the printed circuit board.

Ends of signal relay members (long tails) 55A through 55D are respectively connected to the terminals 53 on the flexible board 59. The other ends of the signal relay members 55A through 55D are respectively connected to the head sliders 16A through 16D. The signal relay members 55A through 55D may be formed by a stainless thin plate that may, for example, be 20 μm thick. Signal lines are formed, in the form of a thin film, on an insulating film on a surface of the stainless thin plate. The magnetic head and the head IC communicate with each other through the signal lines. As illustrated in FIG. 2A, the signal relay members 55A through 55D are pressed against the sidewall portions (V-shaped grooves or slits) of the carriage arms 36A through 36C on the +X side by means of pressure members 60A through 60C.

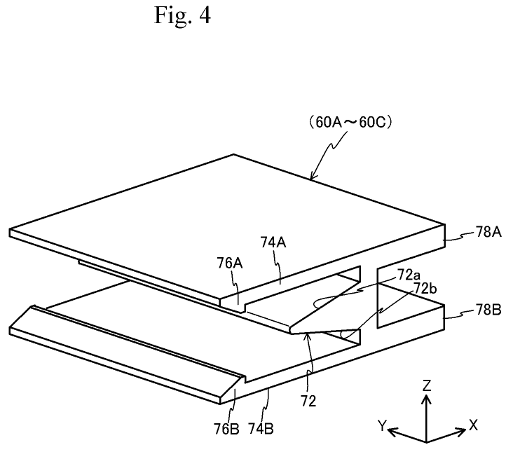

FIG. 4 is a perspective view of the presser members 60A through 60C. Each of the presser members 60A through 60C may be made of, for example, resin and has an approximately H-shaped X-Z cross section. More particularly, each of the presser members 60A through 60 has a projection 72, a pair of arms 74A and 74B, and tab portions 78A and 78B. The projection 72, which is an exemplary structure of a fitting portion of the presser member, has an X-Z cross section shaped into an approximately isosceles triangle and extends in the Y-axis direction. The projection 72 functions as an engagement or fitting portion. The paired arms 74A and 74B are symmetrically arranged vertically across the projection 72. The tab portions 78A and 78B are respectively formed on the +X sides of the arms 74A and 74B.

The projection 72 has a first surface 72a (on the +Z side) in the Y-axis direction, and a second surface 72b (on the −Z side) in the Y-axis direction. The projection 72 has a shape that is fitted into any of the grooves 36Ab through 36Cb respectively provided in the carriage arms 36A through 36C.

A craw portion 76A serving as a second engagement part is provided in an end of the arm 74A on the −X side. The craw portion 76A protrudes from the arm 74A in the −Z direction. A craw portion 76B serving as another second engagement part is provided in an end of the arm 74B on the −X side. The craw portion 76B protrudes from the arm 74B in the X direction. The craw portions 76A and 76B are symmetrically arranged in the vertical direction (Z-axis direction).

The tab portion 78A has an upper surface that is flush with the upper surface of the arm 74A and is provided at the +X side of the projection 72. The tab portion 78B has a lower surface that is flush with the lower surface of the arm 74B and is provided at the +X side of the projection 72.

The presser members 60A through 60C thus configured are respectively attached to the carriage arms 36A through 36C as described below.

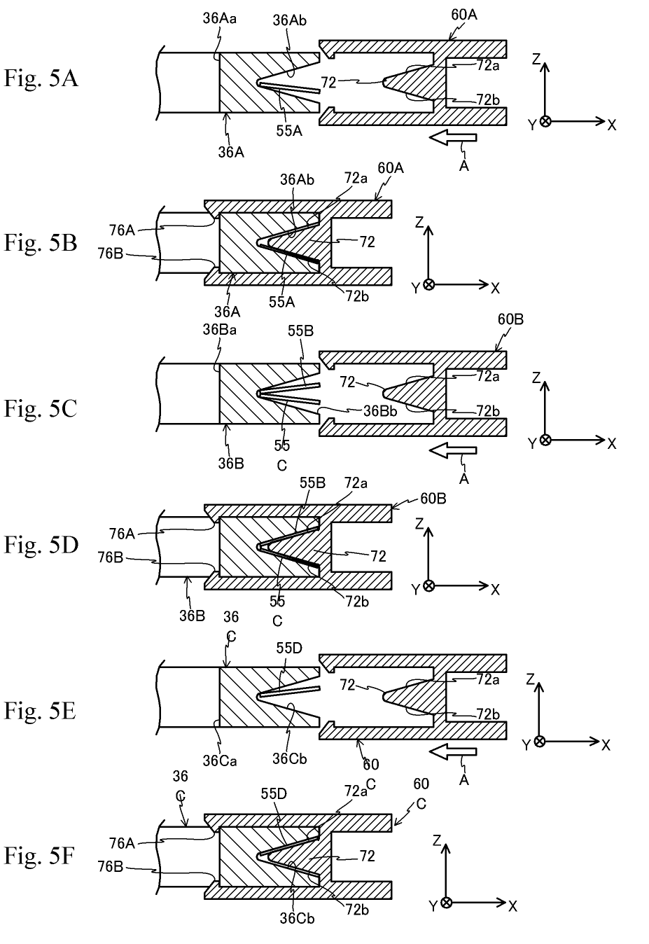

The presser member 60A is attached to the carriage arm 36A, as depicted in FIG. 5A. The signal relay member 55A is arranged in the groove 36Ab of the carriage arm 36A. In this state, the presser member 60A is moved in a direction indicated by an arrow A. In this movement, the arms 74A and 74B of the presser member 60A are elastically deformed. Then, as depicted in FIG. 5B, the craw portions 76A and 76B engage with or hook up corners (edges) of the elliptic hole 36Aa, so that the presser member 60A can be fixed to the carriage arm 36A. In the fixed state, as depicted in FIG. 5B, the signal relay member 55A is interposed between the second or lower surface 72b of the projection 72 and the corresponding surface of the carriage arm 36A that defines the groove 36Ab. Thus, the signal relay member 55A is fixedly held between the presser member 60A and the carriage arm 36A.

Similarly, the presser member 60B is attached to the carriage arm 36B, as depicted in FIG. 5C. The presser member 60B is moved in the direction A in a state in which the signal relay members 55B and 55C are arranged in the groove 36Bb of the carriage arm 36B. As depicted in FIG. 5D, the craw portions 76A and 76B of the presser member 60B hook up corners (edges) of the elliptic hole 36Ba, so that the presser member 60B can be fixed to the carriage arm 36B. In the fixed state, as depicted in FIG. 5B, the signal relay member 55B is interposed between the first surface 72a (upper surface) of the projection 72 and the corresponding surface of the carriage arm 36B that defines the groove 36Bb. Further, the signal relay member 55C is interposed between the second surface 72b (lower surface of the projection 72 and the corresponding surface of the carriage arm 36B that defines the groove 36Bb. Thus, the signal relay members 55B and 55C can be fixedly held between the presser member 60B and the carriage arm 36B.

Similarly, the presser member 60C is attached to the carriage arm 36C, as depicted in FIG. 5E. The presser member 60C is moved in the direction A in a sate in which the signal relay member 55D is arranged in the groove 36C of the carriage arm 36C. As depicted in FIG. 5F, the craw portions 76A and 76B of the presser member 60C hook up corners (edges) of the elliptic hole 36Ca, so that the presser member 60C can be fixed to the carriage arm 36C. In the fixed state, as depicted in FIG. 5F, the signal relay member 55D is interposed between the first surface 72a of the projection 72 and the corresponding surface of the carriage arm 36C that defines the groove 36Cb. Thus, the signal relay member 55D can be fixedly held between the presser member 60C and the carriage arm 36C.

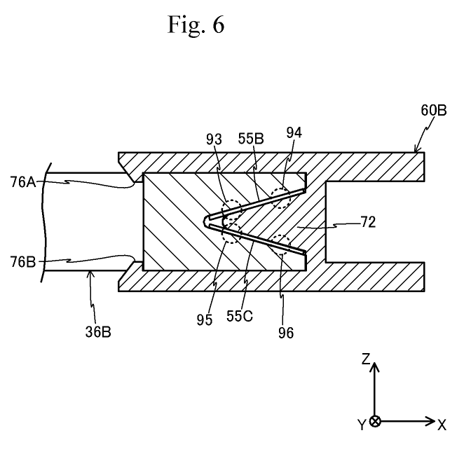

In the present embodiment, as depicted in FIG. 6, the signal relay members 55B and 55C are located at the opposite sides of the projection 72. Thus, a read signal line may be arranged in an area 93 of the signal relay member 55B indicated by a circle of a broken line, and a write signal line may be arranged in another area 94 of the signal relay member 55B. Similarly, a write signal line may be arranged in an area 95 of the signal relay member 55C, and a read signal line may be arranged in another area 96 of the signal relay member 55C. Even in the above arrangement, it is possible to prevent the read and write signal lines in each signal relay member from being extremely close to each order or laying on each other. It is thus possible to restrain crosstalk or injection from the write and read signal lines in each signal relay member and to prevent the heads from being deteriorated or damaged due to excessive current that flows through the heads.

A description will now be given of a way to detach the presser members 60A through 60C from the carriage arms 36A through 36C.

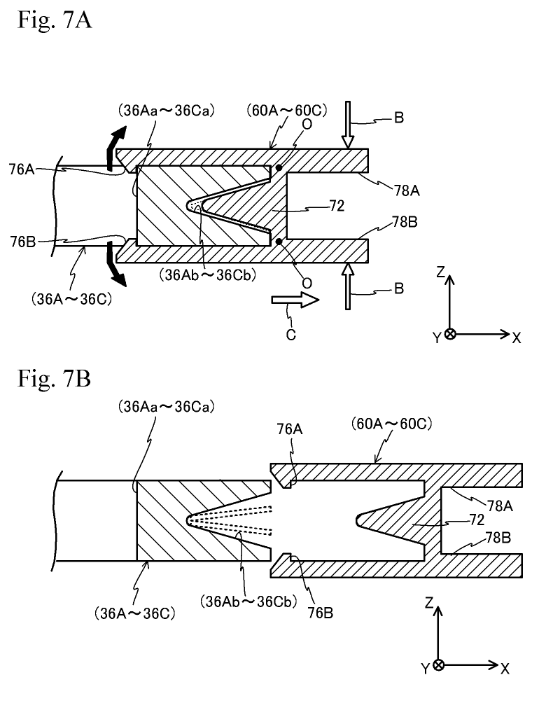

As illustrated in FIG. 7A, the tab portions 78A and 78B receive forces in directions indicated by arrows B so as to be urged closer to each other. Thus, by the principle of leverage having a fulcrum O, the arms 74A and 74B are deformed so as to increase the distance between the craw portions 76A and 76B.

Thus, the presser members 60A through 60C can be detached from the carriage arms 36A through 36C by applying forces to the tab portions 78A and 78B in the directions B and forces thereto in the direction C, as illustrated in FIG. 7A. FIG. 7B depicts a state in which the presser members 60A through 60C are completely detached from the carriage arms 36A through 36C. The forces applied in the directions B disengage the craw portions 76A and 76B from the elliptic holes 36Aa through 36Ca. The forces applied in the direction C move the presser members 60A through 60C in the +X direction.

In the present embodiment, in the fabrication process of the HDD 100, the head performance is inspected after the head stack assembly 20 is assembled. If it is determined that the head performance is not good by the inspection, the head sliders 16A through 16D and the signal relay members 55A through 55D are removed from the carriage arms for the purpose of replacement with new ones. The presser members 60A through 60D can easily be detached from the carriage arms 36A through 36C only by applying forces thereto in the directions B and C, as illustrated in FIG. 7A. Thus, the signal relay members can be replaced with the presser members 60A through 60D being detached. As compared to fixing of the signal relay members by an adhesive or the like, detachment and replacement of the signal relay members can be carried out easily.

As described above, according to the present embodiment, the signal relay members 55A through 55D are held with pressure by fitting the projections 72 of the presser members 60A through 60C into the grooves 36Ab through 36Cb of the carriage arms 36A through 36C. That is, the signal relay members 55A through 55D are interposed between the carriage arms 36A through 36C and the presser members 60A through 60C. It is thus possible to prevent the signal relay members 55A through 55D from moving and causing displacement. Further, it is possible to restrain the signal relay members 55A through 55D from vibrating. The presser members 60A through 60C are fixed to the carriage arms 36A through 36C by engaging the craw portions 76A and 76B with the elliptic holes 36Aa through 36Ca Thus, the presser members 60A through 60C can be disengaged and detached easily. It is thus possible to easily replace the signal relay members 55A through 55C with new ones. The projections 72 are shaped into isosceles triangles, and the grooves 36Ab through 36Cb have corresponding V-shaped cross sections. It is thus possible to easily fit the projections 72 into the grooves 36Ab through 36Cb. Further, it is possible to fixedly hold the signal relay members 55A through 55D in collaboration with the projections 72 and the grooves 36Ab through 36Cb even if these members have some differences introduced in manufacturing.

The HDD 100 of the present invention has improved head positioning due to suppressed vibration of the signal relay members 55A through 55D. It is thus possible to more reliably write data on the magnetic disks 12A and 12B and read data therefrom and to improve the data recording density. The easy replacement work of the signal relay members makes it possible to quickly recover the HDD 100 from initial defect or failure.

In the present embodiment, the two signal relay members 55B and 55C are fixedly held by using the first surface 72a (on the +Z side) of the projection 72 and the second surface 72b (on the −Z side) thereof. It is thus possible to keep the read and right signal lines in each signal relay member away from each other and to prevent the occurrence of crosstalk therebetween. This makes it possible to prevent the heads from being deteriorated or damaged due to excessive current that flows through the heads.

The presser members 60A through 60C are fixed to the carriage arms 36A through 36C by engaging the craw portions 76A and 76B with the elliptic holes 36Aa through 36Ca. With this simple structure, the presser members 60A through 60C can be attached to the carriage arms 36A through 36C.

The presser members 60A through 60C have the tab portions 78A and 78B for widening the distance between the craw portions 76A and 76B. Thus, the presser members 60A through 60C can be easily disengaged with and detached from the carriage arms 36A through 36C.

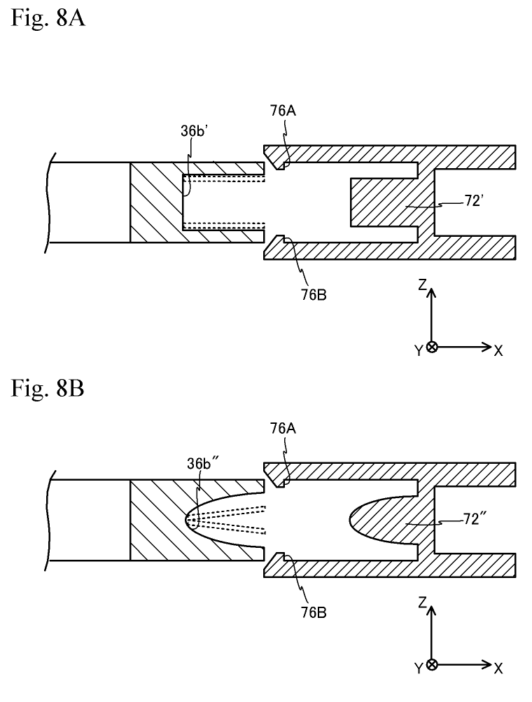

The present embodiment employs the combination of the projections 72 shaped into approximately isosceles triangles and the grooves 36Ab through 36Cb shaped into approximately V-shaped cross sections. The present invention is not limited to the above combination. For example, FIG. 8A illustrates another combination of a projection 72′ shaped into an approximately C-shaped contour in cross section and a groove 36b′ shaped into an approximately C-shaped cross section. This combination brings about the same effects as described before. FIG. 8B illustrates yet another combination of a projection 72″ shaped into an approximately U-shaped or curved contour in cross section and a groove 36b″ shaped into approximately U-shaped or curved cross section. This combination brings about the same effects as described before. The curved contour or cross section makes it possible to hold the signal relay members in a curved state and to improve the rigidity of the signal relay members. This contributes to suppressing vibration of the signal relay members.

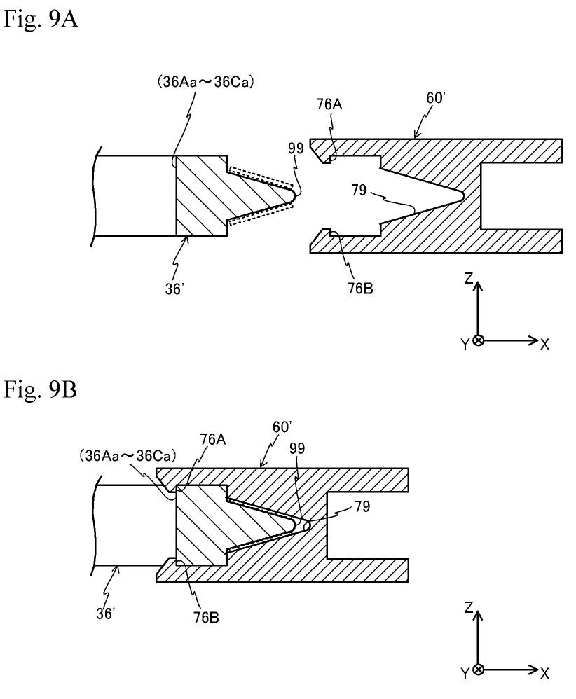

In the present embodiment, the carriage arms 36A through 36C have the grooves 36Ab through 36Cb, and the presser members 60A through 60C have the projections 72. The present invention is not limited to the above arrangement. FIG. 9A illustrates a variation having a carriage arm 36′ with a projection 99, and a presser member 60′ with a groove 79. As depicted in FIG. 9B, the signal relay members can be held between the projection 99 and the groove 79. The presser member 60′ can be detached from the carriage arm 36′ by the simple manner so that the signal relay members can be replaced easily. The projection 99 may have an approximately C-shaped or U-shaped contour in cross section, and the groove 79 may have a corresponding cross section.

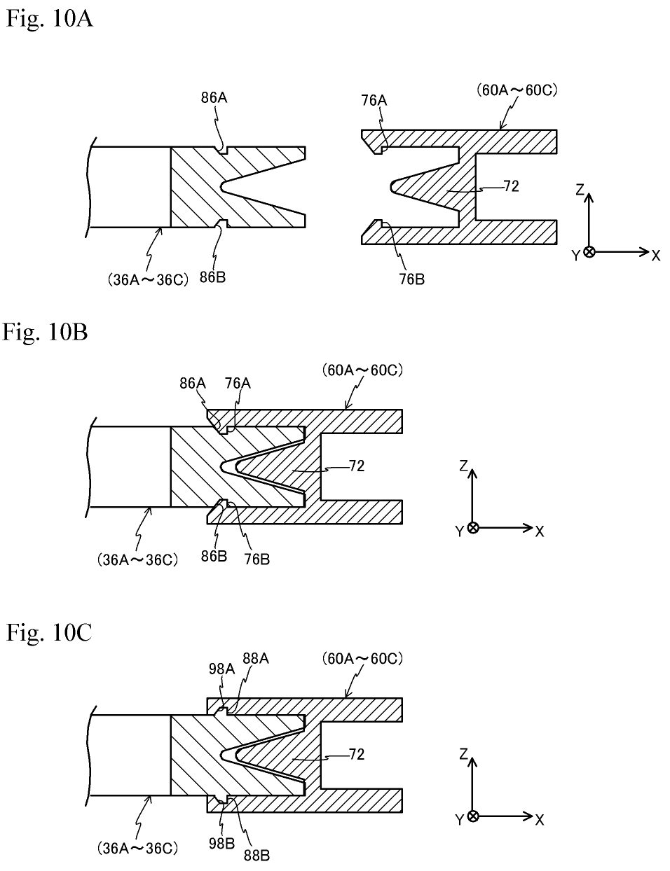

In the present embodiment, the craw portions 76A and 76B of the presser members 60A through 60C are engaged with the elliptic holes 36Aa through 36Ca of the carriage arms 36A through 36C. However, the present invention is not limited to the above structure. FIG. 10A illustrates a variation in which engagement grooves 86A and 86B are respectively formed on the upper (+Z side) and lower (−Z side) surfaces of each of the carriage arms 36A through 36C. As illustrated in FIG. 10B, the craw portions 76A and 76B are respectively engaged with the grooves 86A and 86B so that the presser member 60A through 60C can be fixed to the carriage arms 36A through 36C, respectively. With the above structure, the arms 74A and 74B of the presser members 60A through 60C in the X-axis direction can be shortened and the weight of the head carriage arm 36A through 36C can be lightened. Further, the head positioning accuracy can be improved.

FIG. 10C illustrates yet another variation in which projections 88A and 88B are formed in each of the carriage arms 36A through 36C, and engagement arms 98A and 98B are formed in the arms 74A and 74B of each of the presser members 60A through 60C. With this structure, effects similar to those of the structures illustrated in FIGS. 10A and 10B can be obtained. It is possible to employ a further structure that fixes the presser members 60A through 60C to the carriage arms 36A through 36C by engaging parts of the presser members 60A through 60C with parts of the carriage arms 36A through 36C.

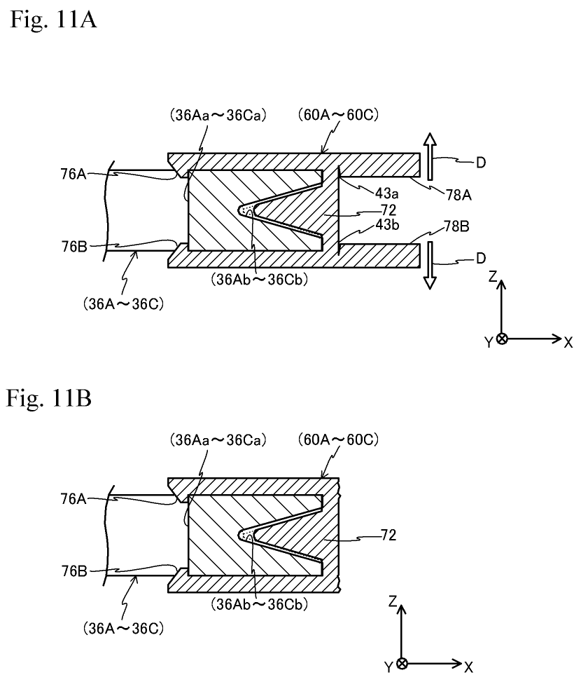

As illustrated in FIG. 11A, slits 43a and 43b may be formed in root portions of the tab portions 78A and 78B of each of the presser members 60A through 60C. Thus, the tab portions 78A and 78B may be removed by applying forces thereto in directions D when the head stack assembly 20 passes the head performance inspection after assembling. It is thus possible to light the weight of the head stack assembly 20 and reduce the influence of airflow caused by rotation of the magnetic disks 12A and 12B. The slits 43a and 43b may be applied to the presser member 60′ depicted in FIGS. 9A and 9B.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A carriage arm assembly comprising:
a carriage arm that holds a head slider and a head IC communicating with the head slider and has a first engagement part between the head slider and the head IC;
a signal relay member that are provided on the carriage arm and relays signals between the head slider and the head IC; and
a presser member that has a second engagement part engaged with the first engagement part and is attached to the carriage arm by engaging the first and second engagement parts with each other,
the signal relay member being held by a projection provided in one of the carriage arm and the presser member and a recess that is provided in the other and is engaged with the projection.

2. The carriage arm assembly according to claim 1, wherein:
the projection has first and second surfaces extending in a longitudinal direction of the signal relay member; and
the signal relay member is held by one of a combination of the first surface and a corresponding surface of the recess and another combination of the second surface and a corresponding surface of the recess.

3. The carriage arm assembly according to claim 2, wherein the first and second surfaces have a flat or curved surface.

4. The carriage arm assembly according to claim 2, wherein the signal relay member has a first member held by the first surface of the projection and a second member held by the second surface of the projection.

5. The carriage arm assembly according to claim 1, wherein:
the second engagement part has a craw portion provided in the presser member; and
the first engagement part has an edge portion engageable with the craw portion.

6. The carriage arm assembly according to claim 5, wherein:
the craw portion has a pair of craws that face each other across the carriage arm in a state in which the presser member is attached to the carriage arm; and
the presser member has a tab portion that increases a distance between the pair of craws due to external force applied to the tab portion.

7. A disk drive comprising:
a disk medium; and
a carriage arm assembly used to write and read data into and from the disk medium,
the carriage arm assembly including:
a carriage arm that holds a head slider and a head IC communicating with the head slider and has a first engagement part between the head slider and the head IC;
a signal relay member that are provided on the carriage arm and relays signals between the head slider and the head IC; and
a presser member that has a second engagement part engaged with the first engagement part and is attached to the carriage arm by engaging the first and second engagement parts with each other,
the signal relay member being held by a projection provided in one of the carriage arm and the presser member and a recess that is provided in the other and is engaged with the projection.

8. The disk drive according to claim 7, wherein:
the projection has first and second surfaces extending in a longitudinal direction of the signal relay member; and
the signal relay member is held by one of a combination of the first surface and a corresponding surface of the recess and another combination of the second surface and a corresponding surface of the recess.

9. The disk drive according to claim 8, wherein the first and second surfaces have a flat or curved surface.

10. The disk drive according to claim 8, wherein the signal relay member has a first member held by the first surface of the projection and a second member held by the second surface of the projection.

11. The disk drive according to claim 7, wherein:
the second engagement part has a craw portion provided in the presser member; and
the first engagement part has an edge portion engageable with the craw portion.

12. The disk drive according to claim 11, wherein:
the craw portion has a pair of craws that face each other across the carriage arm in a state in which the presser member is attached to the carriage arm; and
the presser member has a tab portion that increases a distance between the pair of craws due to external force applied to the tab portion.

13. A presser member comprising:
an engagement part engaged with an engagement part of a carriage arm having a head slider and a head IC; and
a fitting portion engageable with one of a projection and a recess provided in the carriage arm in a state in which the presser member is engaged with the carriage arm,
the fitting portion holding a signal relay member together with said one of the projection and the recess.
